(19) United States
(12) Patent Application Publication
(10) Pub. No.: US 2017/0252748 A1
(43) Pub. Date: Sep. 7, 2017

(54) Holders For Processing And Imaging Of Multiple Microarray Or Microscope Slides

(71) Applicant: Enumeral Biomedical Holdings, Inc., Cambridge, MA (US)

(72) Inventors: Aleksander Jonca, Boston, MA (US); Raymond J. Tang, Foxboro, MA (US)

(21) Appl. No.: 15/061,718

(22) Filed: Mar. 4, 2016

(51) Int. Cl. B01L 9/00

(52) U.S. Cl. CPC B01L 9/523; B01L 9/50; B01L 2300/0848; B01L 2300/0858; B01L 2300/0819; B01L 2200/023; B01L 2300/12; B01L 2300/0609; B01L 2300/0822; B01L 2300/0829; G02B 21/34

(57) ABSTRACT

Microarray slide holders for loading multiple microarray slides into a microscope system are disclosed. An apparatus for simultaneous microengraving and imaging of microwell arrays is disclosed. Also disclosed is a liquid run-off tray for simultaneous processing of multiple microarray slides.

### BACKGROUND

Microwell arrays have been developed for screening and characterizing extremely small minute biological samples as small as a single cell. Individual microwells can have depths and diameters as small as a few micrometers. Planar arrays containing more than 80,000 addressable microwells can fit on a conventional glass microscope slide. Microwell arrays typically are made by casting or molding a planar, biocompatible slab made of an elastomeric material such as poly(dimethylsiloxane) (PDMS), which is affixed to a rigid substrate such as a glass microscope slide. See, e.g., U.S. Pat. No. 7,776,553; and U.S. Pat. No. 8,835,187. Microwell arrays typically are placed in robotic devices for sample and reagent handling, and then transferred to a wide field, automated microscope system for image acquisition and analysis. To create instrument-to-instrument compatibility, most liquid-handling robots and microscope systems are designed to accommodate microarrays placed in modular holders with standardized dimensions, such as the SLAS (Society for Laboratory Automation and Screening, formerly the Society for Biomolecular Sciences) microdevice foot print (e.g., ANSI/SLAS 1-2004). As the numbers of samples to be processed continue to grow, adaptations to improve the high-throughput capabilities of the robots and microscope systems, and to minimize the number of operator interventions, are needed.

### SUMMARY OF THE INVENTION

An example embodiment of the invention provides a microarray slide holder that enables an operator to insert three separate, securely-held, slides, e.g., microarray slides or conventional microscope slides, into a microscope at the same time. It should be understood that the microarray slide holder may be designed to accommodate more or fewer slides. The structures of the microarray slide holder can be designed, accordingly. For purposes of illustration, the embodiments disclosed are provided in reference to three slides. Further, for purposes of illustration, a rectangular shape of slides is described, but other shapes, such as circular, triangular, hexagonal, are also within the scope of embodiments of the invention.

An embodiment of the slide holder may include: (a) two rigid vertical side walls and two rigid vertical end walls in a rectangular configuration open on top and bottom, wherein each wall comprises an outer surface and an inner surface; (b) at least one rigid cross-member extending between the inner surfaces of the side walls, and a horizontal end member along the length of the inner surface of each end wall; and (c) end ledges on opposing ends of each opening. The end members and at least one cross members together form at least one opening, each opening having a size corresponding to a size of a microarray slide with the openings allowing for substantially all of the bottom of the microarray to be exposed. The upper surfaces of the at least one cross member and end members are in the same plane. The end ledges are in the same horizontal plane and located below the upper surfaces of the at least one cross member and end members. Each opening is of a size and shape so that each opening is configured to accommodate a respective microarray slide supported by the ledges, with substantially all of the bottom of the microarray slide being exposed. In some embodiments, the slide holder also has side ledges on the sides of each opening. All the end ledges and side ledges can be in the same horizontal plane. The width of the end ledges and the side ledges can be from about 0.25 mm to about 3.0 mm, or of about 2.0 mm. In some embodiments, each opening is sized and shaped to fit a 25 mm×75 mm glass microscope slide. In some embodiments, each opening is sized and shaped to fit a 1 inch×3 inch glass microscope slide. Some embodiments include on at least one side of each opening a notch; the notch can be sized and shaped to facilitate lifting of a microarray slide out of the opening. In some embodiments, the outside dimensions of the holder conform to an international standard of footprint dimensions for microplates (e.g., ANSI/SLAS 1-2004). In some embodiments, the holder is cast, molded, or milled, as a single piece. In some embodiments, the slide holder is fabricated from a single piece of 7075-T651 aluminum. A slide holder may further include at least one microarray slide located in an opening and supported by the ledges, with substantially all of a bottom side of the microarray slide being exposed.

An embodiment may provide a slide holder that includes a holder component of a pressure exertion mechanism at the center and at both ends of the at least one cross member, and at the center and near both ends of the end members. The holder component of the pressure exertion mechanism can be, e.g., bolt holes, screw holes, magnets or weights.

An embodiment may provide a simultaneous microengraving and imaging plate (SMIP). The SMIP includes: (a) a modified microarray slide holder; (b) a transparent or translucent planar insert having a size and shape corresponding to the walls of the slide holder. The planar insert can fit within the walls of the slide holder and cover essentially the entire interior area of the slide holder. The planar insert includes an insert component of a pressure exertion mechanism, which functions together with the holder component, to exert pressure on microengraving slides or a microwell array contained in the SMIP. This may allow simultaneous microengraving and imaging.

An embodiment may provide a liquid run-off tray. The tray may include a rectangular base with rigid walls and partitions forming at least one fluid tight chambers. Each chamber may include a horizontal slide rest area the size and shape of a microarray slide of interest, an upper slope above one side of the slide rest area, and a lower slope on the opposite side of the slide rest area. The lower slope may begin at a height above the slide rest area approximately equal to the thickness of the slide of interest. The tray may also include a sloped ledge at each end of the slide rest area, which connects the upper slope to the lower slope. The upper slope, sloped ledge and lower slope may all have the same incline within a given tolerance. In some embodiments, the upper slope ends at a height about 0.5 to about 3.0 mm above the surface of the slide. In some embodiments, the slide rest area is sized to fit a 25 mm×75 mm glass microscope slide or a 1 inch×3 inch glass microscope slide. In some embodiments, the upper and lower slopes are from about two to about six mm wide. In some embodiments, the incline of the slopes is from about five to about seven degrees, e.g., about six degrees. In some embodiments, the upper and lower slopes include corrugation at right angles to the incline.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a perspective view of an embodiment of a slide holder according to the invention.

FIG. 2A is a top view of the slide holder of FIG. 1.

FIG. 2B is a side view the slide holder of FIG. 1.

FIG. 2C is a cross-section of the slide holder of FIG. 1, as indicated by the arrows labeled “A” in FIG. 2A.

FIG. 2D is a cross-section of the slide holder of FIG. 1, as indicated by the arrows labeled “B” in FIG. 2A.

FIG. 2E is an end view of the slide holder of FIG. 1.

FIG. 3 is a perspective view of an embodiment of a liquid run off tray according to an embodiment of the invention.

FIG. 4A is a top view of another embodiment of a liquid run off tray.

FIG. 4B is a side view the liquid run off tray of FIG. 4A.

FIG. 4C is a cross-section of the liquid run off tray of FIG. 4A, as indicated by the arrows labeled “A” in FIG. 4A.

FIG. 4D is a cross-section of the liquid run off tray of FIG. 4A, as indicated by the arrows labeled “B” in FIG. 4A.

FIG. 4E is an end view of the liquid run off tray of FIG. 4A.

FIG. 5 is a perspective view of a liquid run-off tray with walls and partitions designed for use with a separate cover over each chamber.

FIG. 6 is a top view of a modified slide holder that can be used with a SMIP insert to form a simultaneous microengraving and imaging plate, or “SMIP.”

FIG. 7 is a picture of a translucent SMIP insert, showing slide depressions and bolt holes.

### DETAILED DESCRIPTION OF THE INVENTION

### Definitions

As used herein, “microarray” means a microwell array, a DNA microarray, or any other ordered array of molecules or cells on a solid substrate that can be subjected to microscopy for image acquisition. Microwell arrays are described in various publications, including, for example, U.S. Pat. Nos. 7,776,553 and 8,835,187. DNA microarrays include, for example, microarray devices commercially available from Affymetrix, Inc. (Santa Clara, Calif.).

As used herein, “microarray slide” means a solid substrate, such as glass or a rigid plastic, on which a microarray is formed or carried.

A description of example embodiments of the invention follows.

### Example 1

### Slide Holder for Microscopy

A first embodiment of the invention provides a slide holder that enables an operator to insert, at the same time, three separate, securely-held, slides into a compatible microscope system, e.g., a Nikon TI-E Inverted Microscope (Nikon Instruments, Melville, N.Y.), or an ImageXpress Micro XLS (Molecular Devices, Sunnyvale, Calif.), or similar microscope system. The slide holder can be used with microarray slides or conventional microscope slides. In a convenient example, the slide holder accommodates three slides, and the slide holder can be modified to accommodate more or fewer slides.

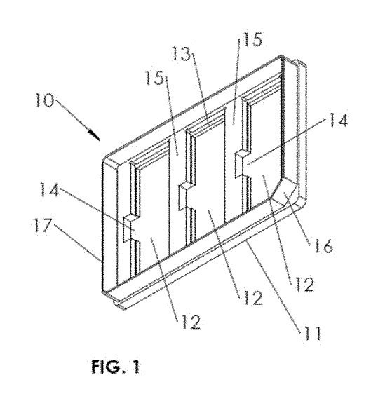

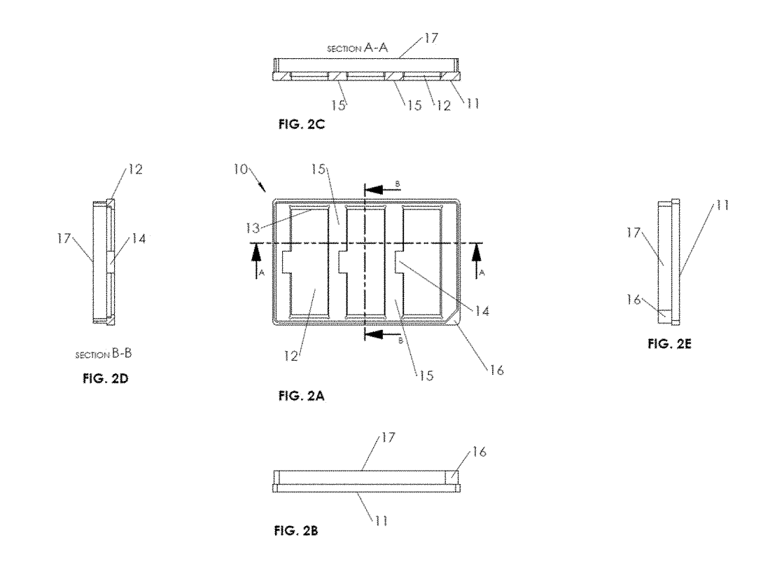

An advantage of embodiments of the invention is an ability to hold the three slides stably and securely, while avoiding the use of clamps, springs or moving parts of any kind. In the embodiment shown in FIGS. 1 and 2A-2E, the base, or lower portion of the walls 11, of the holder 10 conforms to the SLAS microdevice foot print (e.g., ANSI/SLAS 1-2004). While slide holders adapted to other foot prints and formats are within the scope of the invention, conformity to the SLAS foot print enhances compatibility of the slide holder with different instrument systems currently on the market.

In the embodiment shown in FIGS. 1 and 2A-2E, each of the three openings 12, can be sized to hold a single, standard (25 mm×75 mm; or 1 inch×3 inch) glass microscope slide (not shown), but the basic design can be scaled up or down, to accommodate slides of different sizes. The openings 12 are aligned in a row, perpendicular to the long axis of the standard microdevice foot print. Within each opening 12, a microarray slide rests on, i.e., is supported by, a narrow ledge 13 on the ends of the opening, sides of the opening, or both, depending on the particular embodiment. In some embodiments, the width of the ledge 13 is 0.25 mm to 2.0 mm. In other embodiments, there is a 1.0 mm ledge 13 on the ends, and a more narrow, e.g., approximately 0.25 mm ledge on the sides of the opening 12. In general, the ledge 13 is wide enough to provide secure, stable support for the microarray slide, but not so wide as to obstruct microscopy of any portion of the microarray.

As shown in FIGS. 1 and 2A, each opening 12 can include a notch 14 to facilitate loading and unloading of the microrarray slides with a slender tool or a fingertip. Although FIGS. 1 and 2A show a rectangular notch 14 centered on one side of each opening, the size, shape and placement of the optional notch 14 can vary. For example, the notch can be oval or semi-circular, and it can be located anywhere along the side of the opening. Being optional, such a notch can be absent from some embodiments.

The holder 10 comprises two cross members 15. The width of the cross-members 15 can vary. The width can be determined primarily by the size of the slides and the size of the foot print of the holder. FIGS. 1 and 2A, 2B and 2E show an optional geometric modification of one corner 16 of the holder. When present, the asymmetry provided by the modified corner 16 serves to ensure proper orientation of the microarray slide holder 10, when the holder is loaded into a microscope, if there is corresponding asymmetrical geometry in the dock into which the microarray holder 10 fits, in the microscope. In the embodiment shown in FIGS. 1 and 2A-2E, the upper portion of the walls 17 is thinner than the lower portion 11, and set back slightly from the outside of the lower portion of the walls 11. Thus, the thickened lower portion of the walls 11 adds structural strength and forms a stable foundation for the upper portion of the walls 17, enabling the upper portions to be relatively thin and lightweight. In some embodiments, the bottom surface of the cross-members 15 is flush with the bottoms of the lower portions of walls 11, further adding structural strength and stability. Close tolerance in the dimensions of the openings 12 enhances the security with which the microarray slides are held in place.

A microarray slide holder according to some embodiments optionally can be covered with a detachable cover or lid that can be placed on top of the microarray slide holder 10 to protect delicate microarray slides from hazards such as drying out, inadvertently splashed liquids, or airborne dust. In some embodiments, the cover comprises a lip that extends down, e.g., a few millimeters, over the top edges of the walls 17 of the microarray slide holder. The cover can be formed so as to snap in place, or simply to be held in place by a combination of the lip and gravity. The cover can be, but is not required to be, fabricated using the same materials and methods used to fabricate the slide holder 10.

A slide holder 10 can be fabricated from any suitably rigid material, including various metals or hard plastics. A rigid material is one that maintains or substantially maintains its shape after fabrication into slide holder 10, such that it is not readily bendable. Suitable metals include aluminum, corrosion-resistant steel, stainless steel, metal alloys of similar properties, anodized metals, and plastic coated metals. An example metal is 7075-T651 aluminum. Suitable plastics include polystyrene, PMMA (poly(methyl methacrylate)), acrylic, polyethylene, ABS (acrylonitrile butadiene styrene), nylon and PP copolymer (polypropylene copolymer). Selection of fabrication material is a design choice readily made by those of skill in the art. The slide holder 10 may be fabricated as single, integral piece of material. In some embodiments, the slide holder is cast, molded, e.g., injection molded, or milled, as a single piece. The choice of fabrication method depends on the choice of material. In some embodiments, the holder 10 is formed by 3D printing. Software and hardware for 3D printing are commercially available, and their use is within skill in the art. Depending on the choice of material, the slide holder 10 can be milled from a solid block.

### Example 2

### Simultaneous Microengraving and Imaging Plate

Some embodiments of the invention are specifically designed for use with microwell arrays, in a process known as “microengraving.” Microwell arrays can be formed from a thin, planar slab of elastomeric material such as PDMS affixed to a rigid, bottom substrate such as a glass microscope slide. In systems such as those described in U.S. Pat. No. 7,776,553 and U.S. Pat. No. 8,835,187, live cells are loaded into the microwells, and then a rigid, transparent layer, such as a glass microscope slide, subsequently is placed on top of the microwell array, thereby forming a top substrate. The microwell array, which is “sandwiched” between the transparent top and bottom substrates, can be placed in a clamp, to apply gentle pressure, which results in a fluid-tight seal between the top substrate and the microwells. Suitable pre-treatment of the top substrate enables cell derived molecules from individual microwells to be captured on the top substrate, forming a printed microarray on the top substrate. When this microengraving apparatus is taken out of the clamp, the top substrate can be removed and processed separately for imaging. Such formation of the microarray printed on the top substrate is sometimes called “microengraving.” In the prior art, either before the top substrate is put in place, or after it is removed, the cells in the microwells can be imaged, e.g., with fluorescent labels bound to cell surface molecules, to identify cell surface markers, and thus cellular phenotypes. The imaging data from the cells in individual microwells then can be correlated with imaging data separately obtained from the printed microarray on the top substrate. To enable live cells of interest to be recovered following the microengraving process, it is useful to reduce cell death during the process.

An embodiment of the present invention provides a Simultaneous Microengraving and Imaging Plate, or “SMIP,” which makes it possible to view and image cell surface markers on cells in the microwells while the microengraving process is taking place, i.e., with the top substrate in place, with suitable pressure, on the microwell array. Simultaneous microengraving and imaging reduces manipulation and the amount of time required by the overall process, thereby improving viability of the cells involved.

A SMIP comprises: (a) a modified slide holder (a “SMIP holder”); (b) a translucent or transparent, planar SMIP insert that covers essentially the entire interior area of the slide holder; and (c) mechanism such as bolts (and nuts), screws, magnets, or weights, which function to apply suitable pressure by the SMIP insert against slides loaded into the SMIP holder.

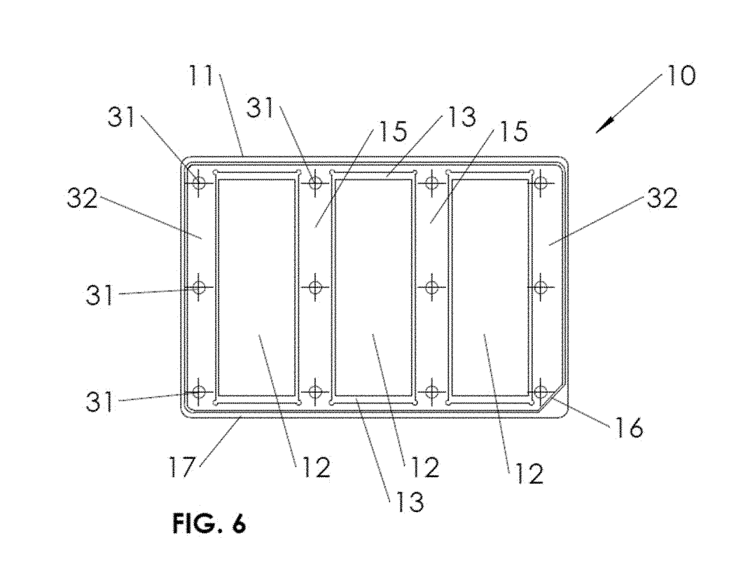

An example embodiment of the SMIP holder is shown in FIG. 6. As illustrated, the cross members 15 and end members 32 comprise non-threaded holes 31 (“bolt holes”), suitable for appropriately sized bolts, which can be tightened with nuts. A bolt hole 31 is located near each end of the cross members 15 and end members 32 (collectively, “outer bolt holes”). One or more bolt holes can be placed between the outer bolt holes on cross members and end members. While additional modifications are possible, the bolt holes are the primary distinction between the SMIP holder illustrated in FIG. 6 and the slide holder described above in Example 1.

In other embodiments, non-threaded bolt holes, are replaced with threaded holes, which can accommodate screws, thereby eliminating the need for nuts. The threaded holes can be in the SMIP holder or, alternatively, in the SMIP insert, preferably with aligned, non-threaded holes in the opposite component. Instead of bolts or screws, magnets, weights or clamps can be employed to obtain suitable pressure on the SMIP insert.

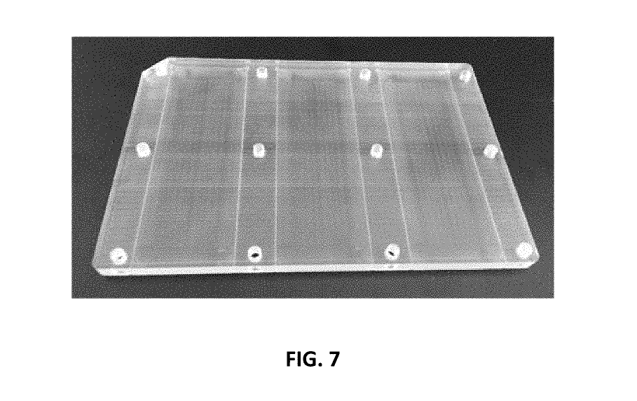

In general, the transparent or translucent SMIP insert is of a size and shape to fit within the vertical walls 17 of the SMIP holder 10 (see FIG. 6) and to cover essentially the entire interior area of the SMIP holder. An example of a SMIP insert, shown in FIG. 7, comprises bolt holes that align with the bolt holes 31 in the SMIP holder 10 exemplified in FIG. 6. As illustrated in FIG. 6, the bolt holes 31 may be evenly spaced to form a pattern with bilateral symmetry. A bilateral symmetry can help maintain even pressure across the entire SMIP insert, when the bolts are tightened.

The SMIP holder can be fabricated using the materials and methods generally described above, with respect to the slide holder. When bolts or screws are used, they can be made of a material that is corrosion resistant, e.g., rigid plastic or stainless steel. The SMIP insert can be made from any suitably rigid material that is transparent or translucent. Suitable materials for fabrication of the SMIP insert include glass and transparent or translucent plastics, including PMMA, acrylic, polystyrene, nylon, PC, and PC glass filled mixtures. In order to enhance performance in fluorescence microscopy, a type of glass or plastic that displays low autofluorescence, e.g., PMMA, may be employed. In some embodiments, the downward-facing surface of the SMIP insert has a slightly recessed area to accommodate each slide, when the SMIP insert is placed on top of slides loaded into the SMIP holder. An example of such a slightly recessed area is visible in FIG. 7. In other embodiments, the downward-facing surface of the SMIP insert has slightly protruding areas that apply pressure directly to the slides. In general, the depth of the slide-supporting ledges 13 (FIG. 6) (relative to the cross-members 15 and end-members 32) should be sufficiently shallow to hold the top surface of the top substrate on each slide in the SMIP holder, such as approximately 0.25 to 1.0 mm above the cross-members and end-members. This allows the downward-facing surface of the SMIP insert to contact the top surface of each top substrate, and thereby exert a suitable pressure.

### Example 3

### Liquid Run-Off Tray

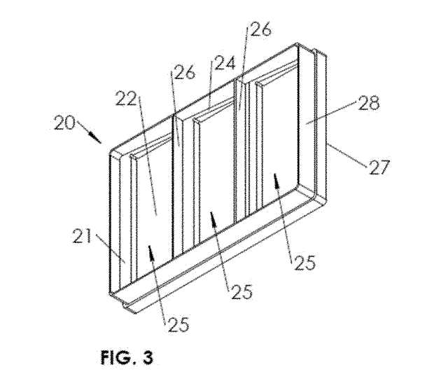

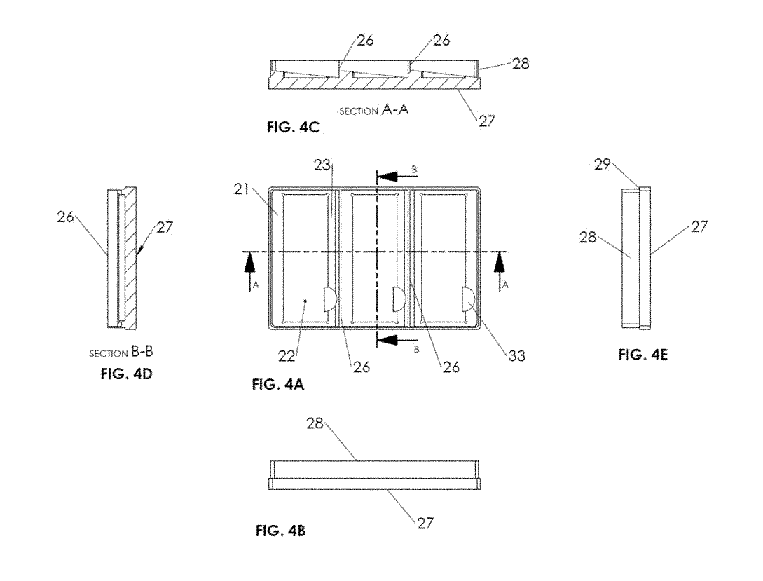

A third embodiment, illustrated in FIGS. 3 and 4A-4E, provides a liquid run-off tray 20 that holds three separate microarray slides or conventional microscope slides for purposes such as staining or washing steps performed by a liquid-handling robot, e.g., a Tecan Evo Liquid Handler (Tecan Group Ltd., Mannedorf, Switzerland). Each slide is held in a separate chamber 25. The run-off tray 20 is designed to facilitate a gentle, controlled, unidirectional flow of a liquid across the entire slide, e.g., in a washing step in an experimental protocol. This is accomplished by introduction of the liquid, e.g., by a row of one to eight pipette tips, or any other suitable liquid handling device, onto an upper slope 21 on one side of the slide, when the slide is placed on a horizontal slide-rest area 22. The liquid flows down the upper slope 21, floods onto the horizontally supported slide, and then drains off the opposite side of the slide onto a lower slope 23, from which the excess liquid can be collected by a suitable method such as aspiration or drainage by gravity.

Useful aspects of the embodiment are for the flow of liquid across the slide to be: (a) sufficiently gentle (non-turbulent) to avoid dislodging cells from the microwells in a microwell array; and (b) unidirectional, to improve washing efficiency. The inventors have discovered that when the upper area beside and above the slide is not sloped, the flow of liquid across the slide displays undesirable turbulence, which can disturb the cells in the microwells, and that the flow is insufficiently unidirectional to result in efficient washing. The inventors have discovered further that adding a slight slope to the area above and beside the slide, to create an upper slope 21, reduces turbulence and results in the desired unidirectional flow.

FIG. 3 illustrates a first embodiment of the tray 20. FIGS. 4A-4E illustrate a second embodiment. In both embodiments, the ends of each horizontal slide-rest area 22 are formed by sloped ledges 24 that connect the upper slope 21 and the lower slope 23, in each chamber 25. Sloped ledges 24 that connect the upper slope 21 and the lower slope 23 can each have about the same incline. The incline of all three slopes can be the same, from, for example, about two to about forty-five degrees, or, from about five to about seven degrees. In some embodiments, the slope is about six degrees. In some embodiments, the upper and lower slopes comprise corrugation at right angles to the incline.

In some embodiments, the walls 28 are set back from the edges of the base 27, thereby forming a base ledge 29 at the bottoms of the walls. This enables optimization of the dimensions of the chambers 25, while independently optimizing the dimensions of the base 27 for different footprint sizes. In some embodiments, the outside dimensions of the base 27 conform to the international standard SLAS footprint dimensions for microplates.

In embodiments such as the one shown in FIGS. 4A-4E, one side of each lower slope comprises a notch 33 of a size and shape to facilitate lifting of a microarray slide from the rectangular opening with a finger or a slender instrument. In some embodiments, each horizontal slide rest area is sized and shaped to fit a microarray slide that is a 25 mm×75 mm, or 1 inch×3 inch, glass microscope slide. In some embodiments, the outside walls and the partitions are about the same height and thickness, where the term “about” can mean within 5%, 10%, or 20% tolerances.

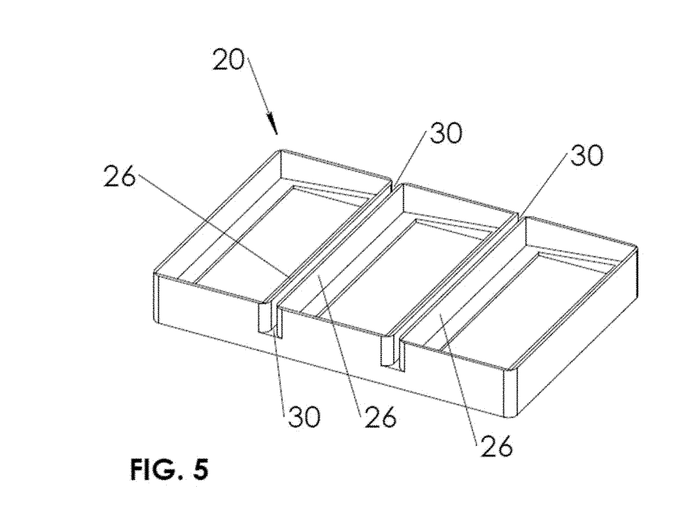

Some embodiments of the tray 20 include a detachable cover, or lid, that can be place on top of the tray to protect delicate microarray slides from hazards such as drying out, inadvertently splashed liquids, or airborne dust. In some embodiments of the tray, each partition 26 comprises a longitudinal space 30, as shown in FIG. 5. Inclusion of this space 30 enables the optional use of a separate cover for each of the three chambers. Whether a cover is sized to fit individual chambers, or sized to cover all the chambers as a group, the cover can comprise a lip that extends downward from one to several millimeters, outside the walls 28. The cover can be formed so as to snap in place, or simply to be held in place by a combination of the lip and gravity. The cover can be fabricated using the same materials and methods used to fabricate the holder, or from any other suitable material.

A run-off tray according to some embodiments can be fabricated from any suitably rigid water-proof material. This includes various metals and plastics. The material may be corrosion resistant and substantially inert to chemicals used in molecular biology and histology. Suitable metals include aluminum, corrosion-resistant steel, stainless steel, metal alloys of similar properties, anodized metals, and plastic coated metals. A useful metal for fabrication of the tray is stainless steel. Suitable plastics include polystyrene, PMMA, acrylic, polyethylene, ABS, nylon and PP copolymer. The choice of material, which may depend on various factors, including cost and durability, is within skill in the art. The base, walls, and partitions of the tray may be formed as single, integral piece of material. The tray may be cast, molded, e.g., injection molded, or milled, as a single piece. The choice of fabrication method depends on the choice of material. In some embodiments, the tray is formed by 3D printing. Software and hardware for 3D printing are commercially available use of which is within skill in the art. Depending on the choice of material, the tray may be milled from a solid block.

Other embodiments are within the following claims.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A slide holder comprising:
two rigid vertical side walls and two rigid vertical end walls, in a rectangular configuration open on top and bottom, wherein each wall comprises an outer surface and an inner surface;
(i) at least one rigid cross-member extending between the inner surfaces of the side walls; and (ii) a horizontal end member along the length of the inner surface of each end wall, so as to form at least one opening, each opening having a size corresponding to a size of a microarray slide with the openings allowing for substantially all of the bottom of the microarray slide to be exposed, wherein the upper surfaces of the at least one cross member and end members are in the same plane;
end ledges on opposing ends of each opening, the end ledges being in the same horizontal plane and located below the upper surfaces of the at least one cross member and end members; and
wherein the openings are of a size and shape so that each opening is configured to accommodate a respective microarray slide supported by the ledges, with substantially all of the bottom of the microarray slide being exposed.

2. The slide holder of claim 1, further comprising side ledges on the sides of each opening, all the end ledges and side ledges being in the same horizontal plane.

3. The slide holder of claim 1, wherein the width of the end ledges and the side ledges is from about 0.25 mm to about 3.0 mm.

4. The slide holder of claim 3, wherein the width of the end ledges and the side ledges is about 2.0 mm.

5. The slide holder of claim 1, wherein each opening is sized and shaped to fit a 25 mm×75 mm glass microscope slide or a 1 inch×3 inch glass microscope slide.

6. The slide holder of claim 1, wherein at least one side of each of the openings comprises a notch.

7. The slide holder of claim 1, wherein the outside dimensions of the holder conform to an international standard of footprint dimensions for microplates.

8. The slide holder of claim 1, wherein the holder is cast, molded, or milled, as a single piece.

9. The slide holder of claim 8, wherein the slide holder is fabricated from a single piece of 7075-T651 aluminum.

10. The slide holder of claim 1, further comprising a holder component of a pressure exertion mechanism at the center and at both ends of the at least one cross member, and at the center and near both ends of the end members.

11. The slide holder of claim 10, wherein the holder component of the pressure exertion mechanism is selected from the group consisting of: bolt holes, screw holes, magnets and weights.

12. An apparatus comprising: (a) the slide holder of claim 10; (b) a transparent or translucent planar insert having a size and shape corresponding to the walls of the slide holder, wherein the planar insert comprises an insert component of a pressure exertion mechanism.

13. The apparatus of claim 12, wherein the planar insert is located within the walls of the slide holder, and the insert component, together with the holder component, exert pressure on a microwell array contained in the apparatus.

14. The apparatus of claim 1, further comprising at least one microarray slide located in an opening and supported by the ledges, with substantially all of a bottom side of the microarray slide being exposed.

15. A tray, comprising a rectangular base comprising rigid walls and partitions forming at least one fluid tight chamber, wherein each chamber comprises: (a) a horizontal slide rest area the size and shape of a microarray slide of interest; (b) an upper slope above one side of the slide rest area; (c) a lower slope on the opposite side of the slide rest area, the lower slope beginning at a height above the slide rest area approximately equal to the thickness of the slide of interest; and (d) a sloped ledge at each end of the slide rest area, which ledge connects the upper slope to the lower slope, with the upper slope, sloped ledge and lower slope all having the same incline.

16. The tray of claim 15, wherein the upper slope ends at a height about 0.5 to about 3.0 mm above the surface of the slide.

17. The tray of claim 15, wherein the slide rest area is sized and shaped to fit a 25 mm×75 mm glass microscope slide or a 1 inch×3 inch glass microscope slide.

18. The tray of claim 15, wherein the upper and lower slopes are from about two to about six mm wide.

19. The tray of claim 15, wherein the incline of the slopes is from about five to about seven degrees.

20. The tray of claim 19, wherein the incline is about 6 degrees.

21. The tray of claim 20, wherein the upper and lower slopes comprise corrugation at right angles to the incline.
